(19) United States
(12) Patent Application Publication
(10) Pub. No.: US 2011/0059843 A1
(43) Pub. Date: Mar. 10, 2011

(54) POROUS BODY PRECURSORS, SHAPED POROUS BODIES, PROCESSES FOR MAKING THEM, AND END-USE PRODUCTS BASED UPON THE SAME

(76) Inventor: Kevin E. Howard, Midland, MI (US)

(21) Appl. No.: 12/988,318

(22) PCT Filed: Apr. 29, 2009
(86) PCT No.: PCT/US2009/042055

§ 371 Date: Nov. 21, 2010

Related U.S. Application Data
(60) Provisional application No. 61/049,299, filed on Apr. 30, 2008.

(51) Int. Cl. B01J 23/00; B01J 23/30; B01J 23/26; B01J 23/46; B01J 23/20; B01J 21/04

(52) U.S. Cl. 502/319; 502/300; 502/305; 502/325; 502/349; 502/353; 502/355

(57) ABSTRACT

The present invention provides porous body precursors and shaped porous bodies. Also included are catalysts and other end-use products based upon the shaped porous bodies and thus the porous body precursors. Finally, processes for making these are provided. The porous body precursors incorporate at least a first oxophilic high oxidation state transition metal. Because the oxophilic high oxidation state transition metal is incorporated into the porous body precursors, it is thought that it will become relatively uniformly distributed therethrough, and thus, provide property enhancements to shaped porous bodies and catalysts based thereupon.

### FIELD OF THE INVENTION

The present invention provides porous body precursors and shaped porous bodies. Also included are catalysts and other end-use products, such as filters, membrane reactors, composite bodies and the like, based upon the shaped porous bodies and thus the porous body precursors. Finally, processes for making these are provided.

### BACKGROUND

Catalysts are important components of many chemical manufacturing processes, and may typically be used to accelerate the rate of reaction in question to a commercially acceptable rate. Utilized in connection with many reactions, catalysts find particular advantageous use in the epoxidation of olefins. In olefin epoxidation, a feed containing an olefin and oxygen is contacted with a catalyst under epoxidation conditions, causing the olefin to react with oxygen to form an olefin oxide. The resulting product mix contains the olefin oxide, as well as any unreacted feed and other combustion products, such as carbon dioxide. The olefin oxide so produced may be reacted with water, alcohol or amines, for example, to produce diols, diol ethers or alkanolamines, respectively.

One particular example of an olefin epoxidation of commercial importance is the epoxidation of alkylenes, or mixtures of alkylenes, and this epoxidation reaction in particular can rely upon high performing catalysts in order to be commercially viable. Typically, catalysts used in alkylene epoxidation comprise a catalytic species deposited on a suitable support/carrier alone or in combination with one or more promoters. All of these can play a part in the performance of the catalyst, and thus, improvements to the properties of one or more of them could result in improvements in the properties/performance of the catalyst.

The discovery or development of such improvements has been the subject of much investigation. Even so, and perhaps indicative of the commercial significance of these reactions, a need yet exists for improved catalysts for the epoxidation of olefins. Desirably, any proposed improvements would be easily incorporated into conventional catalyst manufacture, i.e., and not require substantial additional time or expense to implement. Of course, the improved catalysts would desirably exhibit enhanced selectivity, activity and/or stability over those currently available.

### SUMMARY OF THE INVENTION

The present invention provides porous body precursors and shaped porous bodies that, when utilized to prepare catalysts, provide catalysts with the desired enhanced specificity, activity and/or stability. Specifically, the present invention provides porous body precursors, upon which shaped porous bodies and catalysts may be based, having incorporated therein at least one oxophilic high oxidation state transition metal. Because the oxophilic high oxidation state transition metal is present in the porous body precursors prior to their formation to provide shaped porous bodies, it is expected that the oxophilic high oxidation state transition metal will become relatively uniformly dispersed therethrough, and may provide enhancements in the properties of the shaped porous bodies or catalysts based thereupon. Furthermore, additional steps to add at least a first oxophilic high oxidation state transition metal, or the benefits provided thereby, to shaped porous bodies or catalysts based thereupon are avoided via the inclusion of the same in the porous body precursor, and cost and time savings may be provided. In certain preferred embodiments, a second oxophilic high oxidation state transition metal may be incorporated into the shaped porous bodies or catalysts, and in these embodiments, the first and second oxophilic high oxidation state transition metals can act synergistically to provide enhancements to one or more properties of the catalysts.

In a first aspect, the present invention provides a porous body precursor having incorporated therein at least one oxophilic high oxidation state transition metal. The oxophilic high oxidation state transition metal may comprise e.g., ruthenium, osmium, hafnium, tantalum, tungsten, chromium, or combinations of any number of these. The oxophilic high oxidation state transition metal may be provided as an oxide, e.g., the oxophilic high oxidation state transition metal may comprising ruthenium oxide, osmium oxide, hafnium oxide, tantalum oxide, tungsten oxide, chromium oxide or combinations of these. In preferred embodiments the oxophilic high oxidation state transition metal has an affinity for olefinic bonds, and preferred examples of these include ruthenium, osmium, hafnium, their oxides and combinations thereof. If desired or required, the porous body precursor may also comprise a second oxophilic high oxidation state transition metal. In certain of these embodiments, the first and second oxophilic high oxidation state transition metals may act synergistically to enhance one or more properties of catalysts based thereupon. The porous body precursors desirably comprise transition alumina precursors, transition aluminas, alpha-alumina precursors, or combinations of these.

Because the oxophilic high oxidation state transition metal is added to the porous body precursors it is expected that the oxophilic high oxidation state transition metal will be more uniformly distributed throughout the porous body precursors, as well as shaped porous bodies and catalysts based thereupon, as compared to shaped porous bodies and/or catalysts based upon porous body precursors without the oxophilic high oxidation state transition metal(s) that yet have such components provided in connection therewith It is further expected that this relatively uniform distribution may enhance at least one property of either or both the shaped porous bodies and/or catalysts. A second aspect of the invention thus provides a shaped porous body prepared from a porous body precursor having incorporated therein at least one oxophilic high oxidation state transition metal(s). In preferred embodiments, at least the first oxophilic high oxidation state transition metal has an affinity for olefinic bonds and may thus desirably comprise ruthenium, osmium, hafnium, their oxides or combinations of these. In certain embodiments, a second oxophilic high oxidation state transition metal is desirably provided and may also be incorporated into the porous body precursors, or, may otherwise be provided in connection with the shaped porous bodies or catalysts. In those embodiments of the invention wherein the porous body precursors desirably comprise transition alumina precursors, transition aluminas, alpha-alumina precursors, or combinations of these, the shaped porous bodies may comprise alpha-alumina, and in preferred embodiments may comprise fluoride-affected alpha-alumina.

In a third aspect, processes for providing the shaped porous bodies are also provided, and comprise incorporating into porous body precursors at least one oxophilic high oxidation state transition metal and processing the porous body precursors to provide shaped porous bodies. In certain embodiments, the shaped porous bodies desirably comprise a second oxophilic high oxidation state transition metal, and in these embodiments, the second oxophilic high oxidations state transition metal may be incorporated into the porous body precursors, or may be otherwise incorporated into or deposited upon, the shaped porous bodies. In those embodiments of the invention wherein the shaped porous bodies comprise alpha-alumina that is desirably fluoride-affected, the process may include exposing the porous body precursors and/or the shaped porous bodies to at least one fluorine-containing species in gaseous form or in the form of one or more gaseous or liquid solutions, or combinations of these.

Advantageously, and although the oxophilic high oxidation state transition metals may as promoters when the porous body precursors and shaped porous bodies comprising them are utilized as the basis for, they are incorporated into the porous body precursors rather than being deposited on the shaped porous bodies along with the catalytic species and/or other promoters. As such, it is expected that the at least one oxophilic high oxidation state transition metal will be more uniformly distributed throughout the shaped porous bodies and thus the catalysts. Catalyst properties are, in turn, expected to be enhanced. Also, the inclusion of the oxophilic high oxidation state transition metals in the porous body precursors can substantially reduce or eliminate any desire or need to add similar materials to the catalysts in later manufacturing steps, and time can potentially be saved.

As such, in a fourth aspect, the present invention contemplates such use, and provides catalysts based upon the shaped porous bodies. More specifically, the catalysts comprise at least one catalytic species deposited on the shaped porous bodies, wherein the shaped porous bodies are prepared from porous body precursors having incorporated therein at least one oxophilic high oxidation state transition metal. The catalytic species may comprise one or more metals, solid state compounds, molecular catalysts, enzymes or combinations of these. Desirably, the catalyst is suitable for the catalysis of the epoxidation of olefins, preferably alkylenes, more preferably alkylenes comprising from about 2 to about 6 carbon atoms. Most preferably, the catalysts are suitable for the catalysis of the epoxidation of ethylene or propylene, and in these embodiments of the invention, the catalytic species may preferably comprise a silver component. The oxophilic high oxidation state transition metal may desirably have an affinity for olefinic bonds and in one particularly preferred embodiment, the catalysts may further comprise at least a second oxophilic high oxidation state transition metal. In these embodiments of the invention, it is believed that the first and second oxophilic high oxidation state transition metals may provide synergistic enhancements to one or more properties of the catalysts. The catalysts may also comprise any desired promoters, stabilizers, modifiers or additional additives, and combinations thereof.

Processes for making the catalysts are also provided and comprise selecting shaped porous bodies prepared from porous body precursors having incorporated therein at least one oxophilic high oxidation state transition metal and depositing at least one catalytic species on the shaped porous bodies. Although the catalytic species may be chosen from metals, solid state compounds, molecular catalysts, enzymes or combinations of these, in preferred embodiments, the catalytic species comprises a silver component and the at least one oxophilic high oxidation state transition metal has an affinity for olefinic bonds. The shaped porous bodies preferably comprise alpha-alumina, and more preferably fluoride-affected alpha-alumina, which effect may be provided by exposure of the shaped porous bodies, or porous body precursors, to a fluorine-containing species, typically provided in gaseous form or in the form of one or more gaseous or liquid solutions.

### DETAILED DESCRIPTION OF THE INVENTION

The present specification provides certain definitions and methods to better define the present invention and to guide those of ordinary skill in the art in the practice of the present invention. Provision, or lack of the provision, of a definition for a particular term or phrase is not meant to bely any particular importance, or lack thereof; rather, and unless otherwise noted, terms are to be understood according to conventional usage by those of ordinary skill in the relevant art.

As used herein, the phrase ‘porous body precursor’ is defined as a solid which has been formed into a selected shape suitable for its intended use and in which shape it will be calcined or otherwise processed or reacted to provide a shaped porous body. The phrase, ‘shaped porous body’, in turn, is meant to indicate a solid which has been formed into a selected shape suitable for its intended use and has been further processed so as to have a porosity of greater than at least about 10%. As those of ordinary skill in the art are aware, shaped porous bodies may typically be comprised of many, typically thousands, tens of thousands, hundreds of thousands or even millions of smaller particles, and in the present application, it is the surface morphology or aspect ratio of these smaller particles that is observed or measured and referred to herein. As such, it is to be understood that when particular ranges are indicated as advantageous or desired for these measurements, or that a particular surface morphology has been observed, that these ranges may be based upon the measurement or observation of from about 1 to about 10 particles, and although it may generally be assumed that the majority of the particles may thus exhibit the observed morphology or be within the range of aspect ratio provided, that the ranges are not meant to, and do not, imply that 100% of the population, or 90%, or 80%, or 70%, or even 50% of the particles need to exhibit a surface morphology or possess an aspect ratio within this range.

The present invention provides porous body precursors, upon which shaped porous bodies may be based, comprising at least one oxophilic high oxidation state transition metal. Because at least the first oxophilic high oxidation state transition metal is present in the porous body precursor, additional steps are not required in order to add it to either the shaped porous bodies or catalysts based thereupon, and cost and time savings are provided. Also, because the oxophilic high oxidation state transition metal may be provided along with the other raw materials for the porous body precursors, and mixed, mulled, or otherwise combined, it is expected that it will be relatively uniformly distributed throughout the porous body precursors, and thus, the shaped porous bodies and catalysts based thereupon, as compared to additives that may be otherwise provided in connection with the shaped porous bodies and/or catalysts.

As used herein, the phrase ‘oxophilic high oxidation state transition metal’ is meant to indicate high oxidation state transition metals that are relatively stable, and also that have an affinity for oxygen containing species in these high oxidation states, i.e., so that they can form stable oxo complexes. Examples of these include, but are not limited to ruthenium, osmium, hafnium, tantalum, tungsten chromium and their oxides. In certain preferred embodiments, the oxophilic high oxidation state transition metal will also have an affinity for olefinic, or unsaturated carbon-carbon, bonds. Examples of preferred oxophilic high oxidation state transition metals that also have an affinity for olefinic bonds include ruthenium, osmium, hafnium, their oxides or combinations of these.

In certain preferred embodiments, the porous body precursors, shaped porous bodies, or catalysts may comprise at least a second oxophilic high oxidation state transition metal. It has now been surprisingly discovered, and in particular when a first oxophilic high oxidation state transition metal has already been relatively uniformly incorporated within a porous body precursor, that the provision of a second oxophilic high oxidation state transition metal can provide a synergistic increase in the at least one property enhanced by the provision of the first. The nature of the incorporation of the second oxophilic high oxidation state transition metal is not particularly critical, and it may be incorporated in the porous body precursors, shaped porous bodies or the catalysts by any known suitable method. In preferred embodiments, the second oxophilic high oxidation state transition metal will be provided in connection with the shaped porous bodies or catalysts by impregnation, or other method of association.

The oxophilic high oxidation state transition metals are generally added as chemical compounds to the porous body precursors and typically may be added as oxides, e.g., ruthenium oxide, osmium oxide, hafnium oxide, etc. As used herein, the term “compound” refers to the combination of a particular element with one or more different elements by surface and/or chemical bonding, such as ionic and/or covalent and/or coordinate bonding. The term “ionic” or “ion” refers to an electrically charged chemical moiety; “cationic” or “cation” being positive and “anionic” or “anion” being negative. The term “oxyanionic” or “oxyanion” refers to a negatively charged moiety containing at least one oxygen atom in combination with another element. An oxyanion is thus an oxygen-containing anion. It is understood that ions do not exist in vacuo, but are found in combination with charge-balancing counter ions when added as a compound to the porous body precursors.

Once incorporated into the porous body precursors, and/or during processing to form shaped porous bodies and/or catalysts, or in use in connection with the same, the specific form of the oxophilic high oxidation state transition metal incorporated into the porous body precursor may be unknown, and the oxophilic high oxidation state transition metal may be present without the counterion (typically oxygen) added during the preparation of the porous body precursor. For example, a porous body precursor made with ruthenium oxide may be analyzed to contain ruthenium but not oxide in the finished catalyst. Likewise, while, e.g., osmium oxide, is not ionic, it may convert to ionic compounds during porous body precursor and/or shaped porous body processing or in use in end use applications. For the sake of ease of understanding, the oxophilic high oxidation state transition metal will be referred to in terms of cations and anions regardless of their form in the porous body precursors, shaped porous bodies, catalysts, or catalysts under reaction conditions.

The oxophilic high oxidation state transition metals are provided in the porous body precursors in a “property-enhancing amount”, i.e., an amount that will enhance at least one property of an end-use product based upon the porous body precursor. A “property-enhancing amount” of an oxophilic high oxidation state transition metal refers to an amount of that oxophilic high oxidation state transition metal that provides an improvement in one or more of the catalytic properties of a catalyst comprising the oxophilic high oxidation state transition metal relative to a catalyst not comprising said oxophilic high oxidation state transition metal. Examples of catalytic properties include, inter alia, operability (resistance to run-away), selectivity, activity, conversion, stability and yield.

It is understood by one skilled in the art that one or more of the individual catalytic properties may be enhanced by the “property-enhancing amount” while other catalytic properties may or may not be enhanced or may even be diminished. It is further understood that different catalytic properties may be enhanced at different operating conditions. For example, a catalyst having enhanced selectivity at one set of operating conditions may have enhanced activity and the same selectivity at a different set of operating conditions. Those of ordinary skill in the art may likely intentionally change the operating conditions in order to take advantage of certain catalytic properties even at the expense of other catalytic properties and will make such determinations with an eye toward maximizing profits, taking into account feedstock costs, energy costs, by-product removal costs and the like.

The property-enhancing effect provided by the oxophilic high oxidation state transition metal can be affected by a number of variables such as for example, reaction conditions, catalyst preparative techniques, surface area and pore structure and surface chemical properties of the porous body precursors, the silver and co-promoter content of the catalyst, and the presence of other cations and anions, such as other activators, stabilizer, promoters, enhancers or the like, on the catalyst.

The aforementioned being said, any property-enhancing amount of the oxophilic high oxidation state transition metals may be included in the inventive porous body precursors. Of course, at some level, it is expected that the enhancements to properties in the shaped porous bodies and/or catalysts will reach a maximum, and thereafter, including additional amounts of the oxophilic high oxidation state transition metals would not be practical. Practicality can thus dictate the amount of the at least one oxophilic high oxidation state transition metals, and only as much of the oxophilic high oxidation state transition metal should be used to achieve the maximum effect, and not so much as to unnecessarily add to the cost, or detrimentally impact the processability of the porous body precursors. Perhaps due at least in part to the uniform distribution that is possible when incorporated into the porous body precursors, the oxophilic high oxidation state transition metals can exert their effects at surprisingly low amounts, and it is expected that amounts of less than 10 wt % (based upon the total weight of the porous body precursor), or less than 5 wt %, or even less than 3 wt % will be required to provide the desired enhancements to the shaped porous bodies and/or catalysts prepared from the porous body precursors.

In addition to the oxophilic high oxidation state transition metal(s), the porous body precursors may comprise any of the large number of porous refractory structure or support materials, so long as whatever the porous refractory material chosen, it is relatively inert in the presence of the chemicals and processing conditions employed in the application in which the shaped porous body will be utilized. In many end use applications, the porous refractory material may also desirably have a porous structure and a relatively high surface area. For example, in those embodiments of the invention where the shaped porous bodies are desirably used as the basis of catalysts, it may be important for the shaped porous bodies to be of a physical form and strength to allow the desired flow of reactants, products and any required ballast through the reactor, while also maintaining their physical integrity over the life of the catalyst. In these embodiments of the invention, significant breakage or abrasion may result in undesirable pressure drops within the reactor, and are desirably avoided. It may also be important that the shaped porous bodies, and catalysts based upon the same, be able to withstand fairly large temperature and pressure fluctuations within the reactor. Finally, shaped porous bodies intended for use in catalysis applications will desirably be of high purity and substantially inert so that the shaped bodies themselves will not participate in the separations or reactions taking place around, on or through them in a way that is undesired, unintended, or detrimental.

The porous body precursors may comprise, for example, any of the transition alumina precursors, transition aluminas, hydrated aluminium compounds, alpha-alumina, silicon carbide, silicon dioxide, zirconia, zirconium silicate, graphite, magnesia and various clays, having a porous structure and a relatively high surface area. The use of transition alumina precursors, transition aluminas, or other alpha-alumina precursors, is preferred, as they may at least partially be converted to transition aluminas, or alpha-alumina, respectively, during processing. Generally, in those embodiments of the invention wherein the porous body precursors and shaped porous bodies are intended for end use as catalyst supports, mixtures of hydrated aluminum compounds, such as boehmite, gibbsite, or bayerite, or transition aluminas obtained by thermal dehydration of the hydrated aluminum compounds, may be suitable. Preferred alpha-alumina precursors in these embodiments of the invention comprise pseudo-boehmite, gibbsite, gamma-alumina and kappa-alumina.

As used herein, ‘transition alumina precursors’ are one or more materials that, upon thermal treatment, are capable of being at least partially converted to transition alumina. Transition alumina precursors include, but are not limited to, aluminum tri-hydroxides, such as gibbsite, bayerite, and nordstrandite; and aluminum oxide hydroxides, such as boehmite, pseudo-boehmite and diaspore. ‘Transition aluminas’ are one or more aluminas other than alpha-alumina, which are capable of being at least partially converted to alpha-alumina under thermal treatment at 900° C. or greater. Transition aluminas possess varying degrees of crystallinity, and include, but are not limited to gamma-alumina, delta-alumina, eta-alumina, kappa-alumina, chi-alumina, rho-alumina, and theta-alumina. “Alpha-alumina precursor” means one or more materials capable of being transformed into alpha-alumina, including transition alumina precursors and transition aluminas.

In certain end-use products, e.g., catalysts, it can be advantageous for the porous body precursors to comprise a material that is not only compositionally pure, but also phase pure, or capable of being converted to phase pure material with appropriate processing. As used herein, the phrase ‘compositionally pure’ is meant to indicate a material that is substantially a single substance, with only trace impurities being present. On the other hand, the phrase ‘phase pure’ is meant to indicate a homogeneity in the phase of the material. For example, if the porous body precursors comprise transition alumina precursors, or transition aluminas, that are converted to alpha-alumina during processing to provide the shaped porous bodies, a high phase purity would indicate that the transition aluminas had been converted so that the shaped porous body comprises at least about 90%, or at least 95%, or even about 98% alpha-phase purity (i.e., alpha-alumina). In those applications where such a phase purity is desired, the porous body precursors may desirably comprise one or more transition alumina precursors or transition aluminas. However, the invention is not so limited and the shaped porous body may comprise any combination of transition alumina precursors, transition aluminas and alpha-alumina.

The porous body precursors of the invention may comprise any other components, in any amounts, necessary or desired for processing, such as, e.g., water, acid, binders, dispersants, pore formers, dopants, etc., such as those described in Introduction to the Principles of Ceramic Processing, J. Reed, Wiley Interscience, 1988) to facilitate the shaping, or to alter the porosity, of the porous body precursors and/or shaped porous bodies. Pore formers (also known as burn out agents) are materials used to form specially sized pores in the shaped porous bodies by being burned out, sublimed, or volatilized. Pore formers are generally organic, such as ground walnut shells, granulated polyolefins, such as polyethylene and polypropylene, but examples of inorganic pore formers are known. The pore formers are usually added to the porous body precursor raw materials prior to shaping. During a drying or calcining step or during the conversion of the alpha-alumina precursor to alpha-alumina, the pore formers may typically be burned out, sublimed, or volatilized.

Modifiers may also be added to the porous body precursor raw materials or the porous body precursors to change the chemical and/or physical properties of the shaped porous bodies or end-use products based upon the shaped porous bodies. If inclusion of the same is desired or required, any chosen modifier(s) can be added during any stage of the process, or at one or more steps in the process. As used herein, “modifier” means a component other than the porous refractory material and oxophilic high oxidation state transition metal, added to a porous body precursor or shaped porous body to introduce desirable properties such as improved end-use performance. More particularly, modifiers can be inorganic compounds or naturally occurring minerals which are added in order to impart properties such as strength and, in some cases, change the surface chemical properties of the shaped porous bodies and/or end-use products based thereupon. Non-limiting examples of such modifiers include zirconium silicate, see WO 2005/039757, alkali metal silicates and alkaline earth metal silicates, see WO 2005/023418, each of these being incorporated herein by reference for any and all purposes, as well as metal oxides, mixed metal oxides, for example, oxides of cerium, manganese, tin, and rhenium.

Whatever the raw materials selected for use in the porous body precursors, they are desirably of sufficient purity so that there are limited reactions between any of them. In particular, the oxophilic high oxidation state transition metals should be of sufficient purity so that any impurities are not present in a quantity sufficient to substantially detrimentally impact the properties of the porous body precursors, shaped porous bodies and/or catalysts, i.e., any impurities are desirably limited to not more than 3 wt %, or even not more than 1.5 wt %, of the total weight of the porous body precursors.

The desired components of the porous body precursors, i.e., at least the chosen porous refractory material and the at least one oxophilic high oxidation state transition metal, may be combined by any suitable method known in the art. Further, the oxophilic high oxidation state transition metal and other raw materials may be in any form, and combined in any order, and the order of addition of the oxophilic high oxidation state transition metal to the other raw materials is not critical. Examples of suitable techniques for combining the porous body precursor materials include ball milling, mix-mulling, ribbon blending, vertical screw mixing, V-blending, and attrition milling. The mixture may be prepared dry (i.e., in the absence of a liquid medium) or wet.

Once mixed, the porous body precursor materials may be formed by any suitable method, such as e.g., injection molding, extrusion, isostatic pressing, slip casting, roll compaction and tape casting. Each of these is described in more detail in Introduction to the Principles of Ceramic Processing, J. Reed, Chapters 20 and 21, Wiley Interscience, 1988, incorporated herein by reference. Suitable shapes for porous body precursors will vary depending upon the end use of the same, but generally can include without limitation pills, chunks, tablets, pieces, spheres, pellets, tubes, wagon wheels, toroids having star shaped inner and outer surfaces, cylinders, hollow cylinders, amphora, rings, Raschig rings, honeycombs, monoliths, saddles, cross-partitioned hollow cylinders (e.g., having at least one partition extending between walls), cylinders having gas channels from side wall to side wall, cylinders having two or more gas channels, and ribbed or finned structures. If cylinders, the porous body precursors may be circular, oval, hexagonal, quadrilateral, or trilateral in cross-section. In those embodiments of the invention wherein the porous body precursors are used to prepare shaped porous bodies intended for end use as catalysts, the porous body precursors may desirably be formed into a rounded shape, e.g., pellets, rings, tablets and the like, having diameters of from about 0.1 inch (0.25 cm) to about 0.8 inch (2 cm).

The porous body precursors so formed may then optionally be heated under an atmosphere sufficient to remove water, decompose any organic additives, or otherwise modify the porous body precursors prior to introduction into a kiln, oven, pressure-controlled reaction vessel or other container for any further required for processing into shaped porous bodies. Suitable atmospheres include, but are not limited to, air, nitrogen, argon, hydrogen, carbon dioxide, water vapor, and those comprising fluorine-containing gases or combinations thereof.

Before or during calcination, and in those embodiments of the invention wherein the porous body precursors comprise one or more transition alumina precursors, transition aluminas, or other alpha-alumina precursors, the porous body precursors and/or shaped porous bodies may desirably be fluoride affected, as may be achieved by exposing the porous body precursors and/or shaped porous bodies to at least one fluorine-containing species, as may be provided in gaseous form, in the form of one or more gaseous or liquid solution(s), or via the provision of solid fluorine-containing source operatively disposed relative to the porous body precursors and/or shaped porous bodies, or combinations of these. For advantages provided in processing, any such fluoride effect may desirably be achieved via exposure of the porous body precursors and/or shaped porous bodies to one or more fluorine-containing species in gaseous form or in gaseous solution. The particulars of such gaseous fluoride affectation are described in copending, commonly assigned PCT application no. PCT/US2006/016437, the entire disclosure of which is hereby incorporated by reference herein for any and all purposes.

One preferred method of providing the fluoride effect to the porous body precursors and/or shaped porous bodies comprises heating a vessel containing porous body precursors comprising the at least one oxophilic high oxidation state transition metal to a temperature of from about 750° C. to about 1150° C., preferably from about 850° C. to about 1050° C. A fluorine-containing gas is then introduced into the vessel and can establish a partial pressure within the vessel of between about 1 torr and about 10,000 torr. The partial pressure may be 1, 100, 200, 300, 400, 500, 600, 700, 800, 900, 1000, 2500, 5000, 7500, or 10,000 torr or pressures in between. Preferred partial pressures are below about 760 torr. The porous body precursors are allowed to be in contact with the fluorine-containing gas for a time of about 1 minute to about 48 hours. The time may be 1 minute, 15 minutes, 30 minutes, 45 minutes, 1 hour, 90 minutes, 2 hours, 3 hours, 4 hours, 5 hours, 10 hours, 20 hours, 30 hours, 40 hours or about 48 hours or any amount of time in between. Shorter times for contacting the gas with the porous body precursors are preferred, with times of from about 30 minutes to about 90 minutes being particularly preferred. Of course, and as those of ordinary skill in the art can readily appreciate, the preferred combinations of time and temperature and/or pressure vary with the fluorine-containing gas used, the particular oxophilic high oxidation state transition metal added to the porous body precursors, and any other components of the porous body precursors.

One particularly preferred method of providing a fluoride effect to porous body precursors comprising one or more transition alumina precursors, transition aluminas or other alpha-alumina precursors, comprises heating a vessel containing the porous body precursors to a first temperature in the range of about 850° C. to about 1150° C. prior to introducing the fluorine-containing gas and then heating to a second temperature greater than the first temperature and between about 950° C. and about 1150° C. after introducing the fluorine-containing gas. Desirably, in these embodiments of the invention, the first temperature is increased to the second temperature at a rate of about 0.2° C. to about 4° C. per minute. Whatever time and temperature combination utilized, at least 50% of the transition alumina precursors, transition aluminas or other alpha-alumina precursors are desirably converted to alpha-alumina platelets.

Another particular method for preparing porous body precursors suitable for the preparation of shaped porous bodies desirably comprising fluoride-affected alpha-alumina comprises mixing the at least one oxophilic high oxidation state transition alumina with boehmite alumina (AlOOH) and/or gamma-alumina, peptizing the mixture with a composition containing an acidic component and halide anions (preferably fluoride anions), then forming (e.g., by extruding or pressing) the mixture to provide porous body precursors, and then drying and calcining the porous body precursors at temperatures between 1000° C. and 1400° C. for a time between 45 minutes and 5 hours to provide shaped porous bodies comprising fluoride-affected alpha-alumina.

Shaped porous bodies comprising alpha-alumina according to the invention will desirably have measured surface areas of at least about 0.5 m²/g (more preferably from about 0.7 m²/g to about 10 m²/g), measured pore volumes of at least about 0.5 cc/g (more preferably from about 0.5 cc/g to about 2.0 cc/g), purity (exclusive of the at least one oxophilic high oxidation state transition metal) of at least about 90 percent alpha-alumina particles, more preferably at least about 95 percent alpha-alumina particles, and even more preferably at least about 99 weight percent alpha-alumina particles, the shaped porous bodies also desirably having a median pore diameter from about 1 to about 50 microns. Further, the shaped porous bodies according to the invention will desirably be comprised largely of particles in the form of platelets have at least one substantially flat major surface having a lamellate or platelet morphology, at least 50 percent of which (by number) have a major dimension of less than about 50 microns.

As used herein, the term “platelet” means that a particle has at least one substantially flat major surface, and that some of the particles have two, or sometimes more, flat surfaces. The “substantially flat major surface” referred to herein may be characterized by a radius of curvature of at least about twice the length of the major dimension of the surface. ‘Surface area’, as used herein, refers to the surface area as measured by the BET (Brunauer, Emmett and Teller) method by nitrogen as described in the Journal of the American Chemical Society 60 (1938) pp. 309-316. ‘Pore volume’ (also, ‘total pore volume’ or ‘porosity’) is typically determined by mercury porosimetry. The measurements reported herein used the method described in Webb & Orr, Analytical Methods in Fine Particle Technology (1997), p. 155, using mercury intrusion to 60,000 psia using Micrometrics Autopore IV 9520, assuming 130° contact angle, 0.473 N/M surface tension of Hg. ‘Median pore diameter’ means the pore diameter corresponding to the point in the pore size distribution at which half of the cumulative pore volume of the sample has been measured.

Otherwise, the shaped porous bodies may comprise any suitable shape, as will depend upon the end use of the same. Like the porous body precursors, generally suitable shapes for the shaped porous bodies can include without limitation pills, chunks, tablets, pieces, spheres, pellets, tubes, wagon wheels, toroids having star shaped inner and outer surfaces, cylinders, hollow cylinders, amphora, rings, Raschig rings, honeycombs, monoliths, saddles, cross-partitioned hollow cylinders (e.g., having at least one partition extending between walls), cylinders having gas channels from side wall to side wall, cylinders having two or more gas channels, and ribbed or finned structures. If cylinders, the shaped porous bodies may be circular, oval, hexagonal, quadrilateral, or trilateral in cross-section. In those embodiments of the invention wherein the shaped porous bodies are used to prepare catalysts, the shaped porous bodies may desirably be formed into a rounded shape, e.g., pellets, rings, tablets and the like, having diameters of from about 0.1 inch (0.25 cm) to about 0.8 inch (2 cm).

The shaped porous bodies provided by the invention are particularly well suited for incorporation into many end-use applications as, e.g., catalyst supports, filters, membrane reactors and preformed bodies for composites. As used herein, “carrier” and “support” are interchangeable terms. A carrier provides surface(s) to deposit, for example, catalytic metals, metal oxides, or promoters that a components of a catalyst.

If used as catalyst supports, the shaped porous bodies may advantageously be used as supports for catalysts useful for the epoxidation of alkenes, partial oxidation of methanol to formaldehyde, partial selective oxidation of saturated hydrocarbons to olefins, selective hydroformylation of olefins, selective hydrogenations, selective hydrogenation of acetylenes in cracked hydrocarbon streams, selective hydrogenation of di-olefins in olefin-di-olefin-aromatic streams also known as pyrolysis gasoline, and selective reduction of NOₓ to N₂. Other catalytic applications for the present shaped porous bodies include as carriers for automotive exhaust catalysts for emissions control and as carriers for enzymatic catalysis. In addition to end-use applications as catalytic supports, the inventive shaped porous bodies may also be used for the filtration of materials from liquid or gas streams, see, e.g. Auriol, et al., U.S. Pat. No. 4,724,028. In these applications the shaped porous bodies may either be the discriminating material, or may be the carrier for the discriminating material. Other uses for the present shaped porous bodies include, but are not limited to, as packing for distillations and catalytic distillations.

In one embodiment of the invention, the shaped porous bodies are used as supports for catalysts and such catalysts, as well as processes for making them, are also provided. Typically, such processes include at least depositing one or more catalytic species on the shaped porous bodies. Once deposited, the catalytic species can be bound directly on the surface of the shaped porous bodies of the invention, or, the catalytic species may be bound to a washcoat, i.e., another surface which has been applied to the surface of the shaped porous bodies. The catalytic species may also be covalently attached to a macromolecular species, such as synthetic polymer or a biopolymer such as a protein or nucleic acid polymers, which in turn, is bound either directly to the surface of the shaped porous bodies or a washcoat applied thereto. Further, a deposited catalytic species may reside on the surface of the shaped porous bodies, be incorporated into a lattice provided on the surface of the shaped porous bodies, or be in the form of discrete particles otherwise interspersed among the shape porous bodies.

If the shaped porous bodies are desirably used as supports for catalysts, any catalytic species may be deposited thereupon. Non-limiting examples of catalytic species that may advantageously be supported by the shaped porous bodies include metals, solid state compounds, molecular catalysts, enzymes and combinations of these.

Metals capable of exhibiting catalytic activity include noble metals, e.g. gold, platinum, rhodium, palladium, ruthenium, rhenium, and silver; base metals such as copper, chromium, iron, cobalt, nickel, zinc, manganese, vanadium, titanium, scandium, and combinations of these. Solid state compounds suitable for use as catalytic species include, but are not limited to, oxides, nitrides and carbides, and one particular example of a class of solid state compounds useful as a catalytic species are the perovskite-type catalysts that comprise a metal oxide composition, such as those described by Golden, U.S. Pat. No. 5,939,354, incorporated herein by reference. Exemplary molecular catalytic species include at least metal Schiff base complexes, metal phosphine complexes and diazaphosphacycles. Non-limiting examples of enzymes useful as catalytic species include lipases, lactases, dehalogenases or combinations of these, with preferred enzymes being lipases, lactases or combinations thereof.

The desired catalytic species may be deposited on the shaped porous bodies according to any suitable method, to provide catalysts according to the invention. Typically, metal catalytic species are conveniently applied by solution impregnation, physical vapor deposition, chemical vapor deposition or other techniques. Molecular and enzymatic catalysts may typically be provided onto the shaped porous bodies via covalent attachment directly to the shaped porous bodies, to a wash coat (such as silica, alumina, or carbon) or supported high surface area carbon (such as carbon nanotubes) applied thereto. Enzyme catalysts may also be supported by other supports known in the art, including the carbon nanofibers such as those described by Kreutzer, WO2005/084805A1, incorporated herein by reference, polyethylenimine, alginate gels, sol-gel coatings, or combinations thereof. Molecular catalyst may also be immobilized on the surface(s) of the shaped porous bodies by any of the immobilization generally known to those skilled in the art, such as attachment through silane coupling agents.

The amount of catalytic species may be any suitable amount depending on the particular catalytic species and application, and those of ordinary skill in the catalyst manufacturing art are well equipped to make this determination based upon their knowledge and information in the public arena. Very generally speaking then, typically, at least about 10 percent to essentially all of the shaped porous bodies may be coated with, or otherwise contain, catalytic species.

One particularly preferred class of catalysts according to the invention are those useful for the epoxidation of olefins, and in particular, for the epoxidation of alkylenes, or mixtures of alkylenes. Many references describe these reactions, representative examples of these being Liu et al., U.S. Pat. No. 6,511,938 and Bhasin, U.S. Pat. No. 5,057,481, as well as the Kirk-Othmer's Encyclopedia of Chemical Technology, 4^{th} Ed. (1994) Volume 9, pages 915-959, all of which are incorporated by reference herein in their entirety for any and all purposes. Although the invention is not so limited, for purposes of simplicity and illustration, catalysts according to the invention useful in olefin epoxidations will be further described in terms of and with reference to the epoxidation of ethylene.

In these embodiments of the invention, a high purity shaped porous body is highly desirable. For these applications, a porous body precursor consisting essentially of one or more alpha-alumina precursors is preferred. Shaped porous bodies prepared from the porous body precursors will desirably comprise at least about 90 percent alpha-alumina platelets, more preferably at least about 95 percent alpha-alumina platelets, and even more preferably at least about 99 percent alpha-alumina platelets, exclusive of the oxophilic high oxidation state transition metal.

One method of obtaining such a shaped porous body precursor is to extrude a mixture comprising a alpha-alumina precursor (e.g. pseudo-boehmite or gibbsite), at least one oxophilic high oxidation state transition metal (e.g., ruthenium, osmium, hafnium, tantalum, tungsten, chromium, or combinations of these), an organic binder (e.g. methylcellulose), an organic lubricant (e.g. polyethylene glycol) and, optionally, an organic pore former (e.g. nut shell flour, polypropylene or polyethylene fibers or powders) followed by cutting, drying and debindering/calcining in air.

Shaped porous bodies suitable for end-use application as the basis for ethylene epoxidation catalysts according to the invention may take any of the shapes suitable for carriers or supports, discussed above. Conventional commercial fixed bed ethylene oxide reactors are typically in the form of a plurality of parallel elongated tubes (in a suitable shell) having an outer diameter of from about 1 inches to about 3 inches (2.5 to 7.5 cm) and a length of from about 15 feet to about 45 feet (4.5 to 13.5 m). For use in such fixed bed reactors, the shaped porous bodies will desirably be formed into a rounded shape, such as, for example, spheres, pellets, rings, tablets, and the like, having diameters from about 0.1 inch (0.25 cm) to about 0.8 inch (2 cm).

Catalysts according to this embodiment of the invention may be prepared by impregnating the inventive shaped porous bodies with a solution of one or more silver compounds, or otherwise depositing the silver throughout the pores of the shaped porous bodies and reducing the silver compound as is well known in the art. See for example, Liu, et al., U.S. Pat. No. 6,511,938 and Thorsteinson et al., U.S. Pat. No. 5,187,140, incorporated herein by reference.

Generally, the shaped porous bodies are impregnated with a catalytic amount of silver, which is any amount of silver capable of catalyzing the direct oxidation of, e.g., ethylene, with oxygen or an oxygen-containing gas to the corresponding alkylene oxide. Typically, the shaped porous bodies are impregnated with one or more silver compound solutions sufficient to allow the silver to be provided on the shaped porous bodies in an amount greater than about 5 percent, greater than about 10 percent, greater than about 15 percent, greater than about 20 percent, greater than about 25 percent, preferably, greater than about 27 percent, and more preferably, greater than about 30 percent by weight, based on the weight of the catalyst. Although the amount of silver utilized is not particularly limited, the amount of silver provided in connection with the shaped porous bodies may usually be less than about 70 percent, and more preferably, less than about 50 percent by weight, based on the weight of the catalysts.

Although silver particle size in the finished catalysts is important, the range is not narrow. A suitable silver particle size can be in the range of from about 10 angstroms to about 10,000 angstroms in diameter. A preferred silver particle size ranges from greater than about 100 angstroms to less than about 5,000 angstroms in diameter. It is desirable that the silver be relatively uniformly dispersed within, throughout, and/or on the shaped porous body.

In these embodiments of the invention, the catalysts further may desirably comprise an amount of at least a second oxophilic high oxidation state transition metal. Although the second oxophilic high oxidation state transition metal may be incorporated into the shaped porous body and/or the catalysts via any known method, it may advantageously be included in the either or both silver impregnation solutions. It has now been surprisingly discovered that, when an amount of a second oxophilic high oxidation state transition metal is so provided, the first and second oxophilic high oxidation state transition metals may act synergistically to provide the catalyst with a property, or enhancements to a property, not provided by the weighted average of the property provided to a catalyst by either oxophilic high oxidation state transition metal alone.

As is known to those skilled in the art, there are a variety of known promoters, or materials which, when present in combination with particular catalytic materials, e.g., silver, benefit one or more aspects of catalyst performance or otherwise act to promote the catalyst's ability to make a desired product, e.g., ethylene oxide or propylene oxide. More specifically, and while such promoters in themselves are generally not considered catalytic materials, they typically may contribute to one or more beneficial effects of the catalysts' performance, for example enhancing the rate, or amount, of production of the desired product, reducing the temperature required to achieve a suitable rate of reaction, reducing the rates or amounts of undesired reactions, etc. Furthermore, and as those of ordinary skill in the art are aware, a material which can act as a promoter of a desired reaction can be an inhibitor of another reaction. For purposes of the present invention, a promoter is a material which has an effect on the overall reaction that is favorable to the efficient production of the desired product, whether or not it may also inhibit any competing reactions that may simultaneously occur.

There are at least two types of promoters—solid promoters and gaseous promoters. A solid promoter may conventionally be incorporated into the inventive catalysts prior to their use, either as a part of the shaped porous bodies, or as a part of the silver component applied thereto. Examples of well-known solid promoters for catalysts used to produce ethylene oxide include compounds of potassium, rubidium, cesium, rhenium, sulfur, manganese, molybdenum, and tungsten. Examples of solid promoter and their characteristics as well as methods for incorporating the promoters as part of the catalyst are described in Thorsteinson et al., U.S. Pat. No. 5,187,140, particularly at columns 11 through 15, Liu, et al., U.S. Pat. No. 6,511,938, Chou et al., U.S. Pat. No. 5,504,053, Soo, et al., U.S. Pat. No. 5,102,848, Bhasin, et al., U.S. Pat. Nos. 4,916,243, 4,908,343, and 5,059,481, and Lauritzen, U.S. Pat. Nos. 4,761,394, 4,766,105, 4,808,738, 4,820,675, and 4,833,261, all incorporated herein by reference in their entirety for any and all purposes.

Gaseous promoters, on the other hand, are gas-phase compounds or mixtures thereof which are introduced into a reactor, either alone or with other gas phase reactants, before or during the process desirably catalyzed. Gas phase promoters can desirably further enhance the performance of the catalyst, and may do so either alone, or may work in conjunction with one or more solid promoters. Halide-containing components, e.g., chlorine-containing components, may typically be employed as gaseous promoters in processes involving the epoxidation of alkylenes. See, for example, Law, et al., U.S. Pat. Nos. 2,279,469 and 2,279,470, each incorporated herein by reference in their entirety for any and all purposes.

Gaseous promoters capable of generating at least one efficiency-enhancing member of a redox half reaction pair may also be used, and one example of such a gaseous promoter would be any of those comprising a nitrogen-containing component. See, for example, Liu, et al., U.S. Pat. No. 6,511,938 particularly at column 16, lines 48 through 67 and column 17, line 28, and Notermann, U.S. Pat. No. 4,994,589, particularly at column 17, lines 10-44, each incorporated herein by reference in their entirety for any and all purposes. Alternatively, a suitable precursor compound may also be added such that the desired amount of the salt of a member of a redox-half reaction pair is formed in the catalyst under epoxidation conditions, especially through reaction with one or more of the gas-phase reaction components. The suitable range of concentrations of the precursor of the efficiency enhancing promoter is the same as for the salt. As used herein, the term “salt” does not indicate that the anion and cation components of the salt be associated or bonded in the solid catalyst, but only that both components be present in some form in the catalyst under reaction conditions.

Solid promoters are generally added as chemical compounds to the catalyst prior to its use. As used herein, the term “compound” refers to the combination of a particular element with one or more different elements by surface and/or chemical bonding, such as ionic and/or covalent and/or coordinate bonding. The term “ionic” or “ion” refers to an electrically charged chemical moiety; “cationic” or “cation” referring to a positively charged moiety and “anionic” or “anion” referring to a negatively charged moiety. The term “oxyanionic” or “oxyanion” refers to a negatively charged moiety containing at least one oxygen atom in combination with another element. An oxyanion is thus an oxygen-containing anion. It is understood that ions do not exist in vacuo, but are found in combination with charge-balancing counter ions when added as a compound to the catalyst.

Once incorporated into the catalyst, and/or during the reaction to make ethylene oxide, the specific form of the promoter on the catalyst may be unknown, and the promoter may be present without the counterion added during the preparation of the catalyst. For example, a catalyst made with cesium hydroxide may be analyzed to contain cesium but not hydroxide in the finished catalyst. Likewise, compounds such as alkali metal oxide, for example cesium oxide, or transition metal oxides, for example MoO₃, while not being ionic, may convert to ionic compounds during catalyst preparation or use. Oxyanions, or precursors to oxyanions, may be converted to a cationic or covalent form. In many instances, analytical techniques may not be sufficient to precisely identify the species present. The invention is not intended to be limited by the exact species that may ultimately exist on the catalyst during use and simply for the sake of ease of understanding, the solid promoters will be referred to in terms of cations and anions regardless of their form in the catalyst under reaction conditions.

The catalyst prepared on the inventive shaped porous bodies may contain alkali metal and/or alkaline earth metal as cationic promoters. Exemplary of the alkali metal and/or alkaline earth metals are lithium, sodium, potassium, rubidium, cesium, beryllium, magnesium, calcium, strontium and barium. Other cationic promoters include Group 3b metal ions including lanthanide series metals. In some instances, the promoter may comprise a mixture of cations, for example cesium and at least one other alkali metal, to obtain a synergistic efficiency enhancement as described in U.S. Pat. No. 4,916,243, herein incorporated by reference. Note that references to the Periodic Table herein shall be to that as published by the Chemical Rubber Company, Cleveland, Ohio, in CRC Handbook of Chemistry and Physics, 46th Edition, inside back cover.

The concentration of the alkali metal promoters in the finished catalyst, if desirably included therein, is not narrow and may vary over a wide range. The optimum alkali metal promoter concentration for a particular catalyst will be dependent upon performance characteristics, such as catalyst efficiency, rate of catalyst aging and reaction temperature. More particularly, the concentration of alkali metal (based on the weight of cation, for example cesium) in the finished catalysts of the present invention may vary from about 0.0005 to 1.0 wt. %, preferably from about 0.005 to 0.5 wt. %. The preferred amount of cation promoter deposited on or present on the surface of the shaped porous body or catalyst generally lies between about 10 ppm and about 4000 ppm, preferably between about 15 ppm and about 3000 ppm, and more preferably between about 20 ppm and about 2500 ppm by weight of cation calculated on the total shaped porous body material. Amounts between about 50 ppm and about 2000 ppm may be most preferred.

In those embodiments of the invention wherein the alkali metal cesium is employed as a promoter in combination with other cations, the ratio of cesium to any other alkali metal and alkaline earth metal salt(s), if used, to achieve desired performance is not narrow and may vary over a wide range. The ratio of cesium to the other cation promoters may vary from about 0.0001:1 to 10,000:1, preferably from about 0.001:1 to 1,000:1. Preferably, cesium comprises at least about 10, more preferably, about 20 to 100, percent (weight) of the total added alkali metal and alkaline earth metal in those catalyst embodiments comprising cesium as a promoter.

Examples of anionic promoters which may be employed in catalysts according to the present invention include halides, for example fluorides and chlorides, and oxyanions of elements other than oxygen having an atomic number of 5 to 83 of Groups 3b to 7b and 3a to 7a of the Periodic Table. One or more of the oxyanions of nitrogen, sulfur, manganese, tantalum, molybdenum, tungsten and rhenium may be preferred for some applications. Preferred anionic promoters suitable for use in the catalysts of this invention comprise, by way of example only, oxyanions such as sulfate, SO₄⁻², phosphates, for example, PO₄⁻³, titanates, e.g., TiO₃⁻², tantalates, for example, Ta₂O₆⁻², molybdates, for example, MoO₄⁻²/vanadates, for example, V₂O₄⁻², chromates, for example, CrO₄⁻², zirconates, for example, ZrO₃⁻², polyphosphates, manganates, nitrates, chlorates, bromates, borates, silicates, carbonates, tungstates, thiosulfates, cerates and the like. Halides may also be utilized as anion promoters in the catalysts of the present invention, and include, e.g., fluoride, chloride, bromide and iodide.

It is well recognized that many anions have complex chemistries and may exist in one or more forms, for example, orthovanadate and metavanadate; and the various molybdate oxyanions such as MoO₄⁻², and Mo₇O₂₄⁻⁶ and Mo₂O₇⁻². The oxyanions may also include mixed metal-containing oxyanions including polyoxyanion structures. For instance, manganese and molybdenum can form a mixed metal oxyanion. Similarly, other metals, whether provided in anionic, cationic, elemental or covalent form may enter into anionic structures.

When the promoter comprises rhenium, the rhenium component can be provided in various forms, for example, as the metal, as a covalent compound, as a cation or as an anion. The rhenium species that provides the enhanced efficiency and/or activity is not certain and may be the component added or that generated either during preparation of the catalyst or during use as a catalyst. Examples of rhenium compounds include the rhenium salts such as rhenium halides, the rhenium oxyhalides, the rhenates, the perrhenates, the oxides and the acids of rhenium. However, the alkali metal perrhenates, ammonium perrhenate, alkaline earth metal perrhenates, silver perrhenates, other perrhenates and rhenium heptoxide may also be used. Rhenium heptoxide, Re₂O₇, when dissolved in water, hydrolyzes to perrhenic acid, HReO₄, or hydrogen perrhenate. Thus, for purposes of this specification, rhenium heptoxide can be considered to be a perrhenate, that is, ReO₄. Similar chemistries can be exhibited by other metals such as molybdenum and tungsten.

Promoters comprising manganese may also be utilized in catalysts according to the invention. The manganese species that provides the enhanced activity, efficiency and/or stability is not certain and may be the component added or that generated either during catalyst preparation or during use as a catalyst. Manganese components believed to be capable of acting as catalytic promoters, include, but are not limited to, manganese acetate, manganese ammonium sulfate, manganese citrate, manganese dithionate, manganese oxalate, manganous nitrate, manganous sulfate, and manganate anion, for example permanganate anion, and the like. To stabilize the manganese component in certain impregnating solutions, it may be necessary to add a chelating compound such as ethylenediaminetetraacetic acid (EDTA) or a suitable salt thereof.

Anionic promoters may be provided in any suitable promoting amount, and are typically providing in amounts ranging from about 0.0005 wt % to 2 wt %, preferably from about 0.001 wt % to 0.5 wt % based on the total weight of the catalyst. When used, the rhenium component may often be provided in amounts of at least about 1 ppm, or up to at least about 5 ppm, or even in amounts of between about 10 ppm to about 2000 ppm, or between about 20 ppm and 1000 ppm, calculated as the weight of rhenium based on the total weight of the catalyst.

The promoters for catalyst employing the present invention may also be of the type comprising at least one efficiency-enhancing salt of a member of a redox-half reaction pair which is employed in an epoxidation process in the presence of a gaseous nitrogen-containing component capable of forming a gaseous efficiency-enhancing member of a redox-half reaction pair under reaction conditions. The term “redox-half reaction” is defined herein to mean half-reactions like those found in equations presented in tables of standard reduction or oxidation potentials, also known as standard or single electrode potentials, of the type found in, for instance, “Handbook of Chemistry”, N. A. Lange, Editor, McGraw-Hill Book Company, Inc., pages 1213-1218 (1961) or “CRC Handbook of Chemistry and Physics”, 65th Edition, CRC Press, Inc., Boca Raton, Fla., pages D155-162 (1984). The term “redox-half reaction pair” refers to the pairs of atoms, molecules or ions or mixtures thereof which undergo oxidation or reduction in such half-reaction equations.

Further, the phrase “redox-half reaction pairs” is used herein to include those members of the class of substance which provide the desired performance enhancement, rather than a mechanism of the chemistry occurring. Preferably, such compounds, when associated with the catalyst as salts of members of a half reaction pair, are salts in which the anions are oxyanions, and preferably are oxyanions of a polyvalent atom; that is, the atom of the anion to which oxygen is bonded is capable of existing, when bonded to a dissimilar atom, in different valence states. As used herein, the term “salt” does not indicate that the anion and cation components of the salt must be associated or bonded in the solid catalyst, but only that both components be present in some form in the catalyst under reaction conditions. Potassium is the preferred cation, although sodium, rubidium and cesium may also be utilized, and the preferred anions are nitrate, nitrite and other anions capable of forming nitrate anions under epoxidation conditions. Preferred salts include KNO₃ and KNO₂, with KNO₃ being most preferred.

The amount of any such salt of a member of a redox-half reaction pair utilized in catalysts according to the invention may vary widely, and generally speaking, any amount may be utilized that at least marginally enhances the efficiency of the reaction to be catalyzed. The precise amount will vary depending upon such variables as the gaseous efficiency-enhancing member of a redox-half reaction used and concentration thereof, the concentration of other components in the gas phase, the amount of silver contained in the catalyst, the surface area of the support, the process conditions, for example space velocity and temperature, and morphology of support. Alternatively, a suitable precursor compound may also be added such that the desired amount of the salt of a member of a redox-half reaction pair is formed in the catalyst under epoxidation conditions, especially through reaction with one or more of the gas-phase reaction components. Generally, however, a suitable range of concentration of the added efficiency-enhancing salt, or precursor thereof, calculated as cation, is about 0.01 to about 5%, preferably about 0.02 to about 3%, by weight, based on the total weight of the catalyst. Most preferably the salt is added in an amount of about 0.03 to about 2 wt. %.

The preferred gaseous efficiency-enhancing members of redox-half reaction pairs are compounds containing an element capable of existing in more than two valence states, preferably nitrogen, oxygen, or combinations of these. Most preferably, the gaseous component capable of producing a member of a redox-half reaction pair under reaction conditions is a generally a nitrogen-containing gas, such as for example nitric oxide, nitrogen dioxide and/or dinitrogen tetroxide, hydrazine, hydroxylamine or ammonia, nitroparaffins (for example, nitromethane), nitroaromatic compounds (for example nitrobenzene), N-nitro compounds, and nitriles (for example, acetonitrile).

The amount of nitrogen-containing gaseous promoter useful in catalysts according to the invention can vary widely, and is generally that amount that is sufficient to enhance the performance, e.g., the activity and/or efficiency, of the catalyst in the reaction to be catalyzed. The concentration of the nitrogen-containing gaseous promoter is determined by the particular efficiency-enhancing salt of a member of a redox-half reaction pair used and the concentration thereof, the particular alkene undergoing oxidation, and by other factors including the amount of carbon dioxide in the inlet reaction gases. For example, U.S. Pat. No. 5,504,053 discloses that when the nitrogen-containing gaseous promoter is NO (nitric oxide), a suitable concentration is from about 0.1 ppm to about 100 ppm, by volume, of the gas stream.

Although in some cases it may be preferred to employ members of the same half-reaction pair in the reaction system, that is, both the efficiency-enhancing salt promoter associated with the catalyst and the gaseous promoter in the feedstream, as, for example, with a preferred combination of potassium nitrate and nitric oxide, this is not necessary in all cases to achieve satisfactory results. Other combinations, such as KNO₂/N₂O₃, KNO₃/NO₂, KNO₃/N₂O₄, KNO₂/NO, KNO₂/NO₂ may also be employed in the same reaction system. In some instances, the salt and gaseous members may be found in different half-reactions which represent the first and last reactions in a series of half-reaction equations of an overall reaction.

As alluded to hereinabove, whatever the solid and/or gaseous promoter(s) employed in the present catalysts, they are desirably provided in a promoting amount. A “promoting amount” of a certain promoter refers to an amount of that promoter that works effectively to provide an improvement in one or more of the properties of a catalyst comprising the promoter relative to a catalyst not comprising said promoter. Examples of catalytic properties include, inter alia, operability (resistance to run-away), selectivity, activity, conversion, stability and yield. The promoting effect provided by the promoters can be affected by a number of variables such as for example, reaction conditions, catalyst preparative techniques, surface area and pore structure and surface chemical properties of the support, the silver and co-promoter content of the catalyst, the presence of other cations and anions present on the catalyst. The presence of other activators, stabilizers, promoters, enhancers or other catalyst improvers can also affect the promoting effects.

It is understood by one skilled in the art that one or more of the individual catalytic properties may be enhanced by the “promoting amount” while other catalytic properties may or may not be enhanced or may even be diminished. It is further understood that different catalytic properties may be enhanced at different operating conditions. For example, a catalyst having enhanced selectivity at one set of operating conditions may have enhanced activity and the same selectivity at a different set of operating conditions. Those of ordinary skill in the art may likely intentionally change the operating conditions in order to take advantage of certain catalytic properties even at the expense of other catalytic properties and will make such determinations with an eye toward maximizing profits, taking into account feedstock costs, energy costs, by-product removal costs and the like.

Whatever their amounts, it is desirable that the silver, the one or more solid promoters, and optionally, the at least one second oxophilic high oxidation state transition metal be relatively uniformly dispersed on the shaped porous bodies. A preferred procedure for depositing silver catalytic material, one or more promoters and the second oxophilic high oxidation state transition metal, in those embodiments of the invention where the same is desired, comprises: (1) impregnating a shaped porous body according to the present invention with a solution comprising a solvent or solubilizing agent, silver complex, one or more promoters, and the second oxophilic high oxidation state transition metal and (2) thereafter treating the impregnated shaped porous body to convert the silver compound and effect deposition of silver, the promoter (s), and the at least one second oxophilic high oxidation state transition metal onto the exterior and interior pore surfaces of the shaped porous bodies. Such depositions are generally accomplished by heating the solution containing shaped porous bodies at elevated temperatures to evaporate the liquid within the shaped porous bodies and effect deposition of the silver, promoters and optionally, the second oxophilic high oxidation state transition metal, onto the interior and exterior surfaces of the shaped porous bodies.

Impregnation of the shaped porous bodies is the preferred technique for silver deposition because it utilizes silver more efficiently than coating procedures, the latter being generally unable to effect substantial silver deposition onto the interior surfaces of the shaped porous bodies. In addition, coated catalysts are more susceptible to silver loss by mechanical abrasion. Whatever the manner of impregnation, the silver, one or more promoters, and at least one second oxophilic high oxidation state transition metal may be impregnated simultaneously, or the promoters and/or second oxophilic high oxidation state transition metal may be impregnated prior to, or after, the silver impregnation, and multiple impregnations may be used in order to achieve the desired weight percent of the silver, promoters and/or second oxophilic high oxidation state transition metal on the shaped porous body.

The silver solution used to impregnate the shaped porous bodies may desirably be comprised of a silver compound in a solvent or complexing/solubilizing agent, such as any of the many silver solutions known in the art. The particular silver compound employed may be chosen, for example, from among silver complexes, silver nitrate, silver oxide, or silver carboxylates, such as silver acetate, oxalate, citrate, phthalate, lactate, propionate, butyrate and higher fatty acid salts. Silver oxide complexed with amine is a preferred form of silver for use in preparing catalysts according to the present invention.

A wide variety of solvents or complexing/solubilizing agents may be employed to solubilize silver to the desired concentration in the impregnating solution. Among those suitable for this purpose include, but are not limited to, lactic acid, ammonia, alcohols (such as ethylene glycol), amines and aqueous mires of amines. For example, Ag₂O can be dissolved in a solution of oxalic acid and ethylenediamine to provide a concentration of approximately 30% by weight. Vacuum impregnation of such a solution onto a shaped porous body having a porosity of approximately 0.7 cc/g typically may result in a catalyst comprising approximately 25 wt % silver, based on the entire weight of the catalyst.

Accordingly, if it is desired to obtain a catalyst having a silver loading of greater than about 25 wt % or about 30 wt % or more, it would generally be necessary to subject the shaped porous bodies to at least two or more sequential impregnations of silver, with or without promoters, until the desired amount of silver is deposited on the shaped porous bodies. In some instances, the concentration of the silver salt may desirably be higher in the latter impregnation solutions than in the first. In other instances, approximately equal amounts of silver are deposited during each impregnation. Often, to effect equal deposition in each impregnation, the silver concentration in the subsequent impregnation solutions may need to be greater than that in the initial impregnation solutions. In other instances, a greater amount of silver is deposited on the shaped porous bodies in the initial impregnation than that deposited in subsequent impregnations. Each of the impregnations may be followed by roasting or other procedures to render the silver insoluble.

Well known methods can be employed to analyze the particular amounts of silver and/or solid promoters deposited onto the shaped porous bodies. The skilled artisan may employ, for example, material balances to determine the amounts of any of these deposited components. Alternatively, any suitable analytical technique for determining elemental composition, such as X-ray fluorescence (XRF), may be employed to determine the amounts of the deposited components.

The present invention is applicable to epoxidation reactions in any suitable reactor, for example, fixed bed reactors, continuous stirred tank reactors (CSTR), and fluid bed reactors, a wide variety of which are well known to those skilled in the art and need not be described in detail herein. The desirability of recycling unreacted feed, employing a single-pass system, or using successive reactions to increase ethylene conversion by employing reactors in series arrangement can also be readily determined by those skilled in the art. The particular mode of operation selected is usually dictated by process economics. Conversion of olefin (alkylene), preferably ethylene, to olefin oxide, preferably ethylene oxide, can be carried out, for example, by continuously introducing a feed stream containing alkylene (e.g., ethylene) and oxygen or an oxygen-containing gas to a catalyst-containing reactor at a temperature of from about 200° C. to about 300° C., and a pressure which may vary between about 5 atmospheres (506 kPa) and about 30 atmospheres (3.0 MPa), depending upon the mass velocity and productivity desired. Residence times in large-scale reactors are generally on the order of from about 0.1 seconds to about 5 seconds. Oxygen may be supplied to the reaction in an oxygen-containing stream, such as, air or as commercial oxygen, or as oxygen-enriched air. The resulting alkylene oxide, preferably, ethylene oxide, is separated and recovered from the reaction products using conventional methods.

The following examples are set forth for the purpose of illustrating the invention; but these examples are not intended to limit the invention in any manner. One skilled in the art will recognize a variety of substitutions and modifications of the examples that will fall within the scope of the invention.

### Example 1

### A. Preparation of Porous Body Precursors Having Incorporated Therein at Least One Oxophilic High Oxidation State Transition Metal, and Shaped Porous Bodies Based Thereupon

Porous body precursors incorporating at least one oxophilic high oxidation state transition metal will be prepared in the following manner. Ruthenium oxide (RuOx), osmium oxide (OsOx) and hafnium oxide (HfOx) can be obtained from ESPI metals. Pure ruthenium, osmium and/or hafnium could also be used if desired. Particle size will be approximately 100 to 200 US mesh. Liquids, including water and a source of fluoride anion will be added to the dry raw materials (one or more transition aluminas and the at least one oxophilic high oxidation state transition metal) to obtain an extrudable mixture. Unless otherwise noted, the mixture will be extruded to form porous body precursors in the form of cylinders with an outer diameter of about 0.38 inches, length of about 0.34 inches and wall thickness no greater than about 0.075 inches or as smaller solid cylinders of about ⅛ inch diameter. After drying, the shaped porous bodies will be fired so that the transitional alumina is converted to alpha-alumina. A firing temperature between about 1000° C. and about 1400° C. and a firing time of from about 45 minutes to about 5 hours is used to ensure substantially complete conversion of the one or more transition aluminas to alpha-alumina.

More particularly, to convert the alumina to alpha-alumina and thus provide shaped porous bodies, the formed porous body precursors will be loaded into a reactor consisting of a 6 inch diameter by 22 inch long alumina tube, the reactor will be evacuated, and heated to a temperature of about 840° C. After being at these conditions overnight, the reactor will be filled with Freon HFC-134a to a pressure of 300 torr and held for three hours. The reactor is ramped at 2° C./min to 960° C. and held at 960° C. for 2 more hours. The reactor is cooled at 2° C./min and purged with nitrogen three times.

It is expected that properties for the inventive shaped porous bodies will advantageously approximate those of conventional shaped porous bodies, i.e., the inclusion of the oxophilic high oxidation state transition metal does not substantially detrimentally impact the properties of the inventive shaped porous bodies. By incorporating the at least one oxophilic high oxidation state transition metal in the porous body precursor, later steps for depositing any like additives onto catalysts based on the porous body precursors may advantageously be reduced or eliminated.

TABLE I
Expected Properties of Shaped Porous Bodies (SPBs)

| | A | | | | | | | | | | | |
|---|---|---|---|---|---|---|---|---|---|---|---|---|
| SPB ID | Comparative | B | C | D | E | F | G | H | I | J | K | L |
| Surface | ≧0.5 | Comp | Comp | Comp | Comp | Comp | Comp | Comp | Comp | Comp | Comp | Comp |
| Area | | value ± | value ± | value ± | value ± | value ± | value ± | value ± | value ± | value ± | value ± | value ± |
| (m²/g) | | ≧0.5 | ≧0.5 | ≧0.5 | ≧0.5 | ≧0.5 | ≧0.5 | ≧0.5 | ≧0.5 | ≧0.5 | ≧0.5 | ≧0.5 |
| Calcined | ~1 | Comp | Comp | Comp | Comp | Comp | Comp | Comp | Comp | Comp | Comp | Comp |
| Density | | value ± | value ± | value ± | value ± | value ± | value ± | value ± | value ± | value ± | value ± | value ± |
| (g/cm³) | | ≧0.05 | ≧0.05 | ≧0.05 | ≧0.05 | ≧0.05 | ≧0.05 | ≧0.05 | ≧0.05 | ≧0.05 | ≧0.05 | ≧0.05 |
| Pore | ~0.5 | Comp | Comp | Comp | Comp | Comp | Comp | Comp | Comp | Comp | Comp | Comp |
| Volume | | value ± | value ± | value ± | value ± | value ± | value ± | value ± | value ± | value ± | value ± | value ± |
| (cc/g) | | ≧0.25 | ≧0.25 | ≧0.25 | ≧0.25 | ≧0.25 | ≧0.25 | ≧0.25 | ≧0.25 | ≧0.25 | ≧0.25 | ≧0.25 |
| Crush | ~1 | Comp | Comp | Comp | Comp | Comp | Comp | Comp | Comp | Comp | Comp | Comp |
| Strength | | value + | value + | value + | value + | value + | value + | value + | value + | value + | value + | value + |
| (lb/mm) | | ≧0.5 | ≧0.5 | ≧0.5 | ≧0.5 | ≧0.5 | ≧0.5 | ≧0.5 | ≧0.5 | ≧0.5 | ≧0.5 | ≧0.5 |
| RuOx wt % | 0 | 1 | 2 | 3 | 0 | 0 | 0 | 0 | 0 | 0 | 1 | 1 |
| OsOx wt % | 0 | 0 | 0 | 0 | 1 | 2 | 3 | 0 | 0 | 0 | 1 | 0 |
| HfOx wt % | 0 | 0 | 0 | 0 | 0 | 0 | 0 | 1 | 2 | 3 | 0 | 1 |

### B. Catalyst Preparation Based Upon the Shaped Porous Bodies of IA

Catalysts will be prepared based upon the shaped porous bodies prepared according to part I.A as follows. The shaped porous bodies prepared in part I.A will be vacuum impregnated with a first impregnation silver solution typically containing about 30 weight percent (wt %) silver oxide, from about 15 wt % to about 20 wt % oxalic acid, from about 15 wt % to about 20 wt % ethylenediamine, from about 3 wt % to about 8 wt % monoethanolamine, and from about 25 to about 30 wt % distilled water. The first impregnation solution will typically be prepared by (1) mixing the ethylenediamine (high purity grade) with the distilled water; (2) slowly adding the oxalic acid dihydrate (reagent grade) to the aqueous ethylenediamine solution such that the temperature of the solution does not exceed about 40° C., (3) slowly adding the silver oxide, and (4) adding the monoethanolamine (Fe and Cl free).

The shaped porous bodies will be impregnated in an appropriately sized glass or stainless steel cylindrical vessel which will be equipped with suitable stopcocks for impregnating the shaped porous bodies under vacuum. A suitable separatory funnel will be inserted through a rubber stopper into the top of the impregnating vessel. The impregnating vessel containing the shaped porous bodies will be evacuated to approximately 1-2″mercury absolute for from about 10 to about 30 minutes, after which the impregnating solution will slowly be added to the shaped porous bodies by opening the stopcock between the separatory funnel and the impregnating vessel. After all the solution is emptied into the impregnating vessel (˜15 seconds), the vacuum will be released and the pressure returned to atmospheric. Following addition of the solution, the shaped porous bodies will remain immersed in the impregnating solution at ambient conditions for 5 to 30 minutes, and thereafter be drained of excess solution for from about 10 minutes to about 30 minutes to provide catalysts.

The silver-impregnated catalysts will be roasted as follows to effect reduction of silver on the catalyst surface. The catalysts will be spread out in a single layer on stainless steel wire mesh trays, placed on a stainless steel belt (spiral weave) and transported through a 2″×2″ square heating zone for from about 1 minute to about 5 minutes, or equivalent conditions for a larger belt operation. The heating zone will be maintained at from about 450° C. to about 550° C. by passing hot air upward through the belt and the catalysts at the rate of from about 250 to about 275 standard cubic feet per hour (SCFH). After being roasted in the heating zone, the catalysts will be cooled in the open air to room temperature and weighed.

Next, the silver-impregnated catalysts will be vacuum impregnated with a second silver impregnation solution containing both the silver oxalate amine solution and the catalyst promoters. The second impregnation solution will be composed of all of the drained solution from the first impregnation plus a fresh aliquot of the first solution, or a new solution will be used. The promoters, in either aqueous solution or neat form, will be added with stirring in order to solubilize them, and will be added in sufficient amounts to reach the desired target levels on the finished catalysts. Two molar equivalents of diammonium EDTA will be added with the manganese promoter in order to increase the stability of the manganese-containing ion in the impregnation solution. The impregnation, draining and roasting steps for this second impregnation will be carried out analogously to the first impregnation.

The twice-impregnated finished catalysts will again be weighed, and based upon the weight gain of the catalysts in the second impregnation, the weight percent of silver and the concentration of the promoters will be calculated. The promoter levels will be adjusted to shaped porous body surface area. The estimated results of these calculations are provided in Table II. On Table II, the comparative catalysts are all based upon comparative shaped porous body A, and comparative catalyst A, A2 and A3 differ only in the promoters and/or amounts of promoters and/or silver that are utilized/impregnated. As is shown in Table II, it is expected that the amounts of silver and promoters capable of being impregnated upon the inventive catalysts will advantageously approximate the levels capable of being impregnated on conventional catalysts, i.e., the inclusion of the at least one oxophilic high oxidation state transition metal does not substantially detrimentally impact the impregnability of the inventive catalysts.

TABLE II
Expected Catalyst Properties

| Catalyst ID | Ag (wt %) | Cs (ppm) | Mn (ppm) | SO₄ (ppm) | K (ppm) | Re (ppm) |
|---|---|---|---|---|---|---|
| A | ~33 | ~450 | ~65 | ~80 | | |
| Comparative | | | | | | |
| B | Comp value A ± | Comp value A ± | Comp value A ± | Comp value A ± | — | — |
| 1 wt % RuOx | ≧0.5 | ≧20 | ≧5 | ≧10 | | |
| C | Comp value A ± | Comp value A ± | Comp value A ± | Comp value A ± | — | — |
| 2 wt % RuOx | ≧0.5 | ≧20 | ≧5 | ≧10 | | |
| D | Comp value A ± | Comp value A ± | Comp value A ± | Comp value A ± | — | — |
| 3 wt % RuOx | ≧0.5 | ≧20 | ≧5 | ≧10 | | |
| E | Comp value A ± | Comp value A ± | Comp value A ± | Comp value A ± | — | — |
| 1 wt % OsOx | ≧0.5 | ≧20 | ≧5 | ≧10 | | |
| F | Comp value A ± | Comp value A ± | Comp value A ± | Comp value A ± | — | — |
| 2 wt % OsOx | ≧0.5 | ≧20 | ≧5 | ≧10 | | |
| G | Comp value A ± | Comp value A ± | Comp value A ± | Comp value A ± | — | — |
| 3 wt % OsOx | ≧0.5 | ≧20 | ≧5 | ≧10 | | |
| A2 | ~40 | — | ~150 | — | ~1500 | |
| Comparative | | | | | | |
| H | Comp value A2 ± | — | Comp value A2 ± | — | Comp value A2 ± | |
| 1 wt % HfOx | ≧0.5 | | ≧5 | | ≧100 | |
| I | Comp value A2 ± | — | Comp value A2 ± | — | Comp value A2 ± | |
| 2 wt % HfOx | ≧0.5 | | ≧5 | | ≧100 | |
| J | Comp value A2 ± | — | Comp value A2 ± | — | Comp value A2 ± | |
| 3 wt % HfOx | ≧0.5 | | ≧5 | | ≧100 | |
| A3 | ~38 | ~600 | ~60 | ~150 | — | ~250 |
| Comparative | | | | | | |
| K | Comp value A3 ± | Comp value A3 ± | Comp value A3 ± | Comp value A3 ± | — | Comp value A3 ± |
| 1 wt % RuOx + | ≧0.5 | ≧20 | ≧5 | ≧10 | | ≧15 |
| 1 wt % OsOx | | | | | | |
| L | Comp value A3 ± | Comp value A3 ± | Comp value A3 ± | Comp value A3 ± | — | Comp value A3 ± |
| 1 wt % RuOx + | ≧0.5 | ≧20 | ≧5 | ≧10 | | ≧15 |
| 1 wt % HfOx | | | | | | |
| M | Comp value A3 ± | Comp value A3 ± | Comp value A3 ± | Comp value A3 ± | — | Comp value A3 ± |
| Cat H + 1 wt % | ≧0.5 | ≧20 | ≧5 | ≧10 | | ≧15 |
| HfOx¹ | | | | | | |

¹Impregnated with impregnation solution 2

### C. Use of Inventive and Comparative Catalysts Prepared According to I.B to Catalyze Ethylene Epoxide Reactions

A single-pass tubular reactor made of 0.25 inch OD stainless steel (wall thickness 0.035 inches) will be used for catalyst testing. The inlet conditions of the reactor that will be used are shown in Table III.

TABLE III
Ethylene Epoxidation Process Conditions

| | Oxygen Process | |
|---|---|---|
| | Conditions-I | |
| Component | Mole % | |
| Ethylene | 30.0 | |
| Oxygen | 8.0 | |
| Ethane | 0.5 | |
| Carbon Dioxide | 6.5 | |
| Nitrogen | Balance of gas | |
| Parts per million | 3.5 | |
| Ethyl Chloride | | |
| Type of Reactor | Tube | |
| Amount of | 0.5 | g |

| | |
|---|---|
| Catalyst | |
| Total Outlet | 120 cc/min |
| Flow Rate | |

The pressure will be maintained constant at about 200 psig for the tube reactors. Ethyl chloride concentration will be adjusted to maintain maximum efficiency. Temperature (° C.) needed to produce 1.7 mole % ethylene oxide and catalyst efficiency (selectivity) at the outlet are typically measured and regarded as indicative of catalyst performance.

The catalyst test procedure is as follows: Approximately 5 g of catalyst will be crushed with a mortar and pestle, and then sieved to 30/50 U.S. Standard mesh. From the meshed material, 0.5 g will be charged to the reactor. Glass wool will be used to hold the catalyst in place. The reactor tube will be fitted into a heated brass block which has a thermocouple placed against it. The block will be enclosed in an insulated box. Feed gas will be passed over the heated catalyst at a pressure of 200 psig. The reactor flow will be adjusted and recorded at standard pressure and room temperature. Measurements of efficiency/selectivity and activity/temperature will be made under steady state conditions.

Table IV shows the expected temperature and selectivity as the total cumulative production of the reactor increases over time. It is expected that, by including the at least one oxophilic high oxidation state transition metal in the porous body precursors, the distribution of the same will be more uniform throughout the shaped porous bodies, and that catalysts prepared from the shaped porous bodies may thus exhibit greater selectivity. It is further expected that those catalyst comprising at least two oxophilic high oxidation state transition metals, whether both included in the porous body precursors, or a first is included in the porous body precursor and a second later impregnated on the catalyst, may exhibit synergistically greater selectivity than the comparative catalysts.

TABLE IV

| | Day 18 (~8Mlb | Day 18 (~8Mlb | Day 27 (~16Mlb | Day 27 (~16Mlb | Day 59 (~24Mlb | Day 59 (~24Mlb |
|---|---|---|---|---|---|---|
| | EO/CF) | EO/CF) | EO/CF) | EO/CF) | EO/CF) | EO/CF) |
| Catalyst ID | Selectivity (%) | Temperature (° C.) | Selectivity (%) | Temperature (° C.) | Selectivity (%) | Temperature (° C.) |
| A | ~82 | ~240 | ~82 | ~245 | ~82 | ~250 |
| Comparative | | | | | | |
| B: 1 wt % | Comp value A + | Comp value A − | Comp value A + | Comp value A − | Comp value A + | Comp value A − |
| RuOx | ≧0.1 | ≧0.1 | ≧0.1 | ≧0.1 | ≧0.1 | ≧0.1 |
| C: 2 wt % RuOx | Comp value A + | Comp value A − | Comp value A + | Comp value A − | Comp value A + | Comp value A − |
| | ≧0.1 | ≧0.1 | ≧0.1 | ≧0.1 | ≧0.1 | ≧0.1 |
| D: 3 wt % | Comp value A + | Comp value A − | Comp value A + | Comp value A − | Comp valueA + | Comp value A − |
| RuOx | ≧0.1 | ≧0.1 | ≧0.1 | ≧0.1 | ≧0.1 | ≧0.1 |
| E: 1 wt % OsOx | Comp value A + | Comp value A − | Comp value A + | Comp value A − | Comp value A + | Comp value A − |
| | ≧0.1 | ≧0.1 | ≧0.1 | ≧0.1 | ≧0.1 | ≧0.1 |
| F: 2 wt % OsOx | Comp value A + | Comp value A − | Comp value A + | Comp value A − | Comp value A + | Comp value A − |
| | ≧0.1 | ≧0.1 | ≧0.1 | ≧0.1 | ≧0.1 | ≧0.1 |
| G: 3 wt % | Comp value A + | Comp valueA − | Comp value A + | Comp value A − | Comp value A + | Comp value A − |
| OsOx | ≧0.1 | ≧0.1 | ≧0.1 | ≧0.1 | ≧0.1 | ≧0.1 |
| A2 | ~82 | ~240 | ~82 | ~245 | ~82 | ~250 |
| Comparative | | | | | | |
| H: 1 wt % HfOx | Comp value A2 + | Comp value A2 − | Comp value A2 + | Comp value A2 − | Comp value A2 + | Comp value A2 − |
| | ≧0.1 | ≧0.1 | ≧0.1 | ≧0.1 | ≧0.1 | ≧0.1 |
| I: 2 wt % HfOx | Comp value A2 + | Comp value A2 − | Comp value A2 + | Comp value A2 − | Comp value A2 + | Comp value A2 − |
| | ≧0.1 | ≧0.1 | ≧0.1 | ≧0.1 | ≧0.1 | ≧0.1 |
| J: 3 wt % HfOx | Comp value A2 + | Comp value A2 − | Comp value A2 + | Comp value A2 − | Comp value A2 + | Comp value A2 − |
| | ≧0.1 | ≧0.1 | ≧0.1 | ≧0.1 | ≧0.1 | ≧0.1 |
| A3 | ~82 | ~240 | ~82 | ~245 | ~82 | ~250 |
| Comparative | | | | | | |
| K | Comp value A3 + | Comp value A3 − | Comp value A3 + | Comp value A3 − | Comp value A3 + | Comp value A3 − |
| 1 wt % RuOx + | ≧0.2 | ≧0.2 | ≧0.2 | ≧0.2 | ≧0.2 | ≧0.2 |
| 1 wt % OsOx | | | | | | |
| L | Comp value A3 + | Comp value A3 − | Comp value A3 + | Comp value A3 − | Comp value A3 + | Comp value A3 − |
| 1 wt % RuOx + | ≧0.2 | ≧0.2 | ≧0.2 | ≧0.2 | ≧0.2 | ≧0.2 |
| 1 wt % HfOx | | | | | | |
| M | Comp value A3 + | Comp value A3 − | Comp value A3 + | Comp value A3 − | Comp value A3 + | Comp value A3 − |
| Cat H + 1 wt % | ≧0.2 | ≧0.2 | ≧0.2 | ≧0.2 | ≧0.2 | ≧0.2 |
| HfOx² | | | | | | |

²Impregnated with impregnation solution 2

We claim:

1. A porous body precursor having incorporated therein at least one oxophilic high oxidation state transition metal.

2. The porous body precursor of claim 1, wherein the at least one oxophilic high oxidation state transition metal comprises ruthenium, osmium, hafnium, tantalum, tungsten, chromium, their oxides or combinations of these.

3. The porous body precursor of claim 2, comprising at least a second oxophilic high oxidation state transition metal.

4. A shaped porous body prepared from a porous body precursor having incorporated therein at least one oxophilic high oxidation state transition metal.

5. The shaped porous body of claim 4, wherein the porous body precursor comprises one or more transition alumina precursors, transition aluminas, alpha-alumina precursors, or combinations of these.

6. The shaped porous body of claim 5, wherein the shaped porous body comprises one or more transition alumina precursors, transition aluminas, alpha-alumina precursors, alpha-alumina, or combinations of these.

7. The shaped porous body of claim 6, wherein at least a portion of any alpha-alumina is fluoride-affected.

8. A process for making a shaped porous body comprising incorporating into a porous body precursor at least one oxophilic high oxidation state transition metal and processing the porous body precursor into a shaped porous body.

9. A catalyst comprising at least one catalytic species deposited on a shaped porous body, wherein the shaped porous body is prepared from a precursor porous body having incorporated therein at least one oxophilic high oxidation state transition metal.

10. A process for making a catalyst comprising:
a) selecting a shaped porous body prepared from a porous body precursor having incorporated therein at least one oxophilic high oxidation state transition metal;
b) depositing at least one catalytic species on the shaped alumina body.
